(19) United States
(12) Patent Application Publication
(10) Pub. No.: US 2012/0014750 A1
(43) Pub. Date: Jan. 19, 2012

(54) DECONTAMINATION/BIOREMEDIATION OF SOILS AND/OR WATERS CONTAMINATED BY ORGANIC AND/OR INORGANIC COMPOUNDS

(75) Inventors: André Fabricio Paranhos Torres, Sao Paulo (BR); Rosmary Aparecida De Nadai, Sao Paulo (BR); Ronaldo do Nascimento, Sao Paulo (BR); José Carlos Moretti, Sao Paulo (BR)

(73) Assignee: Rhodia Poliamida E Especialdades LTDA, Sao Paulo (BR)

(21) Appl. No.: 12/676,635

(22) PCT Filed: Aug. 28, 2008
(86) PCT No.: PCT/IB08/02278

§ 371 Date: Sep. 29, 2010

(30) Foreign Application Priority Data
Sep. 5, 2007 (BR) PI0705607-9

(51) Int. Cl. B09C 1/10

(52) U.S. Cl. 405/128.75

(57) ABSTRACT

Decontamination/bioremediation of soils contaminated by organic and/or inorganic compounds includes the addition of a natural substrate containing nutrients to the contaminated soil, a period of time of anaerobic rest of said soil with control of the oxidation-reduction potential, of the humidity rate, of the field capacity and of the temperature, and thereafter the aeration of same; also decontaminated/bioremediated are surface or underground waters contaminated by organic and/or inorganic compounds, as the method for the bioremediation of contaminated soil is provided as the natural substrate containing nutrients and added to the soil reaches the level of the water and/or aquifer table contaminated by the organic and/or inorganic compounds, thus inducing the bioremediation thereof.

The present invention relates to a method for the bioremediation of soils contaminated by organic and/or inorganic compounds comprising the addition of a natural substrate containing nutrients to the contaminated soil, anaerobic rest of said soil with control of the redox potential, moisture level, field capacity and temperature, and the aeration of the latter. The invention further comprises a method for the bioremediation of surface water or groundwater contaminated by organic and/or inorganic compounds, as well as a method for the bioremediation of contaminated soils, provided that the natural substrate containing nutrients added to said soils reaches the water table and/or aquifer contaminated by organic and/or inorganic compounds leading to the bioremediation of said water.

Soil and water contaminated by toxic agricultural wastes, pesticides and, notably, by organochlorine compounds, as well as soils contaminated by petroleum and/or petroleum derivatives and/or petroleum distillates, such as oils and greases, total petroleum hydrocarbons, aromatic and nonaromatic hydrocarbons, as well as heavy metals, are harmful to human health and to the environment. Accordingly, various regulations have been established for purposes of prevention or correction. Thus, there is increasing demand for decontamination or bioremediation of these media.

Various methods are applied for the treatment of soil and water, such as incineration, thermal desorption and chemical treatment. The technical and/or economic results of these methods are often unsatisfactory. Moreover, at many contaminated sites, application of these techniques proves to be unsuitable and/or unworkable, notably owing to the presence of large volumes of contaminated material.

Moreover, various bioremediation technologies have been investigated and disclosed, for the purpose of appropriate decontamination and reclamation of contaminated soil and/or water. However, these technologies do not give significant results with respect to, in particular, the degradation of organic and/or inorganic compounds, notably in the case of large volumes of contaminated material.

Moreover, the objectives of bioremediation are not always achieved: either the decontamination is incomplete, and/or degradation takes a very long time.

The present invention is based on the biodegradation technique according to which the organic and/or inorganic compounds, halogenated organic compounds and/or heavy metals, present in the samples of residues, contaminated soil and/or water, are biotransformed to harmless compounds.

The term “soil” is used generically here, and comprises sand, clay and rock structures and combinations thereof, as well as sediments and muds.

Said method can be applied, notably, to soil and/or water contaminated by: petroleum residues, such as oils, greases, total petroleum hydrocarbons (TPH), aromatic and nonaromatic hydrocarbons in general, residues containing heavy metals, residues containing toxic agricultural wastes and pesticides in general and residues containing halogenated organic compounds.

Said method can notably be used for the bioremediation of the following organochlorine compounds: hexachlorobenzene; 1,2,3,4-tetrachlorobenzene; hexachlorobutadiene; chloromethane; pentachlorophenol; 1,2,4,5-tetrachlorobenzene, pentachlorobenzene, hexachloroethane, chlorobenzene, 1,1,1,2-tetrachloroethane, vinyl chloride, 2-chlorotoluene, methylene chloride, octachlorostyrene, 4-chlorotoluene, trans-1,2-dichloroethylene, 1,1,2,2-tetrachloroethane, 1,1-dichloroethane, 1,2,3-trichloropropane, 2,2-dichloropropane, 1,3-dichlorobenzene, cis-1,2-dichloroethylene, 1,2-dichlorobenzene, 1,4-dichlorobenzene, 1,1,1-trichloroethane, carbon tetrachloride, chloroform, 1,2,3-trichlorobenzene, 1,2,4-trichlorobenzene, 1,1-dichloropropene, 1,3-dichloropropane.

Thus, the method according to the invention permits the application of bioremediation to contaminated soil and/or water without displaying the disadvantages of the known methods.

Moreover, the present invention permits the decontamination of soil and/or water contaminated by organic and inorganic compounds that are extremely stable, persistent and refractory, such as: hexachlorobenzene, chlorophenols, polychlorinated biphenyls (PCB), lindane, benzene and hexavalent chromium.

Another advantage of this method is the capacity for treatment of soil and/or water contaminated by large amounts of organic and/or inorganic substances.

Yet another advantage of said method is that, as said contaminants have a short degradation half-life, it can thus be applied in different sites and on different scales.

Thus, the method of bioremediation according to the present invention is based on the biodegradation technique by which the contaminants of the soil and/or water are biotransformed to harmless compounds, in degradation half-lives significantly lower than the values referred to in the technical literature and in the prior art. In this sense, the present invention is thus feasible both technically and economically for the treatment of large amounts of contaminated soil and/or water.

The microorganisms for use in the method according to the present invention comprise in particular the aerobic, anaerobic and facultative, native microorganisms. These microorganisms are known by a person skilled in the art, and can be consulted in various Type Culture Collections.

These microorganisms, when stimulated in the conditions of the method according to the present invention, multiply rapidly, giving a reduced bioconversion time.

Moreover, the method according to the present invention is extremely advantageous, causing the degradation and/or the transformation of the organic and/or inorganic compounds present in contaminated soil and/or water, to environmentally acceptable levels.

The present invention relates to a method for the bioremediation of contaminated soil comprising at least the following stages:

(a) addition, directly or indirectly, of a natural substrate containing nutrients to the contaminated soil;

(b) anaerobic rest of the contaminated soil, with a moisture level that is between about 20% and 100% of the field capacity and at a temperature between about 15° C. and 70° C.; and

(c) aeration of said soil.

Advantageously the method comprises alternation between one or more cycles of anaerobic and/or aerobic treatment, i.e. several cycles comprising at least stages (a) to (c), or only stages (b) and (c).

More advantageously, the method includes a natural substrate containing nutrients comprising substances of vegetable and/or animal origin.

Even more advantageously the method in question includes a natural substrate containing nutrients of vegetable origin comprising wood chips, pieces and/or residues, sawdust, sugarcane bagasse, residues of vegetation and/or vegetable oil cake.

In particular the method includes a natural substrate containing nutrients of animal origin comprising sludges and/or slurries from animals, such as manure from cattle, echinates and poultry, notably chicken droppings, fresh or not.

More particularly the method includes a natural substrate containing nutrients that can be added to contaminated soils in solid and/or liquid form.

Even more particularly the method includes a natural substrate containing nutrients of animal origin, comprising sludges and/or slurries from animals, added to the soil in solid form.

Advantageously the method includes a natural substrate containing nutrients of animal origin, comprising sludges and/or slurries from animals, added to the soil in liquid form.

More advantageously the method includes a natural substrate containing nutrients of animal origin, comprising sludges and/or slurries from animals, added to the soil in solid and/or liquid form.

Even more advantageously the method can be carried out in situ and/or ex situ.

Preferably the method for the bioremediation of contaminated soil comprising a natural substrate containing nutrients added to said soil reaches the water table and/or aquifer contaminated by organic and/or inorganic compounds, leading to the bioremediation of said water.

Advantageously the method for the bioremediation of surface water or groundwater contaminated by organic substances comprises the direct or indirect addition, to said water, of a natural substrate containing nutrients comprising substances of vegetable and/or animal origin.

More advantageously the method for the bioremediation of surface water or groundwater comprises the direct or indirect addition, to said water, of a natural substrate containing nutrients comprising substances of animal origin.

Even more advantageously the method for the bioremediation of surface water or groundwater comprises the direct or indirect addition, to said water, of a natural substrate containing nutrients comprising substances of animal origin such as sludges and/or slurries from animals.

Preferably the method for the bioremediation of surface water or groundwater comprises the addition, to said water, of a natural substrate containing nutrients comprising substances of animal and/or vegetable origin in solid and/or liquid form.

More preferably the method for the bioremediation of contaminated soil comprises a natural substrate mixture containing nutrients added to the contaminated soil, in a proportion approximately between 5% and 95%, by weight of contaminated soil.

Even more preferably the method for the bioremediation of contaminated soil comprises a natural substrate mixture containing nutrients added to the contaminated soil, in a proportion approximately between 30% and 70%, by weight of contaminated soil.

Advantageously the method of bioremediation comprises the addition of a source of nitrogen.

More advantageously the method of bioremediation includes a source of nitrogen comprising organic and/or inorganic nitrogen.

Even more advantageously the method of bioremediation includes mineral nitrogen comprising ammonium nitrate, ammonium sulfate, ammonia nitrogen, nitrite and/or mixtures thereof.

Preferably, the method of bioremediation comprises the supplementary addition of micronutrients, macronutrients and/or additives.

More preferably the method of bioremediation includes additives comprising acids, oxides, peroxides, surfactants, surface-active substances and/or alkaline substances.

Even more preferably the method for the bioremediation of contaminated soil includes a stage of anaerobic rest, with a redox potential reaching a value below, approximately, −50 mV.

Advantageously the method of bioremediation envisages a pH approximately between 2 and 12.

More advantageously the method of bioremediation envisages a pH approximately between 7 and 10.

Even more advantageously the method of bioremediation envisages a pH obtained by adding calcium carbonate, dolomitic limestone and/or rock phosphate.

Even more advantageously the method of bioremediation comprises supplementary addition of microorganisms.

Preferably the method for the bioremediation of contaminated water and/or soil comprises halogenated organic compounds as the organic contaminant.

More preferably the method for the bioremediation of contaminated water and/or soil comprises oxyhalogenated compounds and/or heavy metals and/or their complexes and/or their salts and/or mixtures thereof as the contaminant.

Advantageously said invention further comprises a natural substrate in liquid and/or solid form containing nutrients comprising substances of vegetable and/or animal origin.

Preferably the invention in question comprises the use of said substrate in a method for the bioremediation of water and/or soil contaminated by organic and/or inorganic compounds.

More preferably the invention relates to a composition containing a substrate of animal and/or vegetable origin in liquid and/or solid form comprising nutrients for use in the method for the bioremediation of water and/or soil contaminated by organic and/or inorganic compounds.

Even more preferably the invention relates to a composition in liquid and/or solid form containing a substrate of animal and/or vegetable origin comprising nutrients for use in the method for the bioremediation of water and/or soil contaminated by organic and/or inorganic compounds.

Preferably the invention in question relates to a composition in liquid and/or solid form comprising a substrate of animal and/or vegetable origin containing nutrients for use in the method for the bioremediation of water and/or soil contaminated by organic and/or inorganic compounds.

The method according to the present invention further comprises the addition of a source of nitrogen to the soil and/or water to be treated. “Source of nitrogen” means, according to the present invention, mineral nitrogen. According to a preferred embodiment of the present invention, said source of nitrogen can be one of the following: ammonium nitrate, ammonium sulfate, ammonia nitrogen, nitrite and mixtures thereof. The supplementary addition of a source of nitrogen can be carried out when we require a quick decrease in the content of organic and/or inorganic matter in the soil and/or water, i.e. the method becomes even quicker owing to the accelerated bioconversion of the organic and/or inorganic matter.

In particular embodiments of the method according to the present invention, there is supplementary addition of micronutrients and/or macronutrients and/or additives, to make the contaminant more available to the degradation performed by the microorganisms. As examples of said additives, we may mention: acids, oxides, peroxides, surfactants, surface-active substances and alkaline substances.

Relating to soils, the method according to the present invention further comprises a stage of anaerobic rest, which is understood as the degradation of the organic and/or inorganic contaminants in anaerobic conditions.

The conditions favorable to the development of the indigenous microorganisms for effecting the degradation of the organic and/or inorganic fraction in the method according to the present invention comprise, among others, control of the parameters of temperature, redox potential, moisture level and pH.

Particularly during the stage of anaerobic rest, the redox potential must reach a value below approximately 0 mV, preferably below −50 mV, until substantial degradation of the contaminants has taken place. Maintaining the redox potential at the stated values is notably beneficial for the efficient application of the method according to the present invention.

Additionally, the redox potential can be maintained by adding reducing agents, such as organic acids and/or salts thereof.

The moisture level must be adjusted according to the soil that is to undergo bioremediation, i.e. it depends on the water retention capacity (WRC) of said soil.

Moreover, the water content must be adjusted advantageously so as to obtain a moist mixture without it being very pasty. Typically the moisture level is between approximately 20% and 100% of the field capacity.

Alternatively water or liquids for lixiviation or percolation can be added to adjust the moisture level.

With respect to the pH, more suitable values are between approximately 7 and 10. Said pH values can be adjusted by means of pH correcting agents that are known by a person skilled in the art. In the terms of the present invention, these substances comprise buffering and neutralizing agents. Advantageously, the pH is obtained by adding calcium carbonate, dolomitic limestone, rock phosphate or a mixture thereof.

The aeration stage according to the present invention can be carried out by means of any suitable method comprising mechanical and/or physical agents, for example tractors, plows, shovels, spades, among others.

The method of bioremediation according to the present invention comprises one or more anaerobic-aerobic cycles, until the decontamination is complete. Advantageously said decontamination is achieved by means of cycles with a duration between 1 week and 5 months.

Preferably, the anaerobic stage has a duration between and 3 months and the aerobic stage has a duration between 2 weeks and 1 month.

Alternatively the method of bioremediation according to the present invention comprises the supplementary addition of anaerobic microorganisms. As mentioned previously for the indigenous microorganisms, said supplementary microorganisms comprise any microorganism known by a person skilled in the art, native or not to the soil to be submitted to bioremediation.

The present invention will be better understood from the description of the examples, which are purely for purposes of illustration, and do not in any way limit the scope of the invention.

### EXAMPLE 1

In the laboratory, two samples of contaminated soil each of 1 kg are separated, in glass containers, as shown in Table 1 below.

Then the natural organic substrate is added, constituted of chicken droppings and sawdust, in the proportions stated in Table 1, and homogenization of the mixture is carried out, under suitable reaction conditions of moisture level, pH and aeration, resulting in a favorable situation of the redox potential, as well as the development of indigenous microorganisms.

TABLE 1

| Sample | Ingredients |
|---|---|
| Sample I | Contaminated soil + natural substrate 20% w/w |
| Sample II | Contaminated soil + natural substrate 40% w/w |

Table 2 presents some reaction parameters for the anaerobic stage.

TABLE 2

| Sample | Field capacity (%) | Redox potential (mV) |
|---|---|---|
| I | 40 to 75 | Less than 50 |
| II | 40 to 75 | Less than 50 |

During the aerobic phase the redox potential reached values above 50 mV, maintaining the water retention field capacity of the mixture between approximately 40% and 65%.

Then, the results obtained by monitoring total organochlorine compounds (TOCC) and hexachlorobenzene (HCB) were analyzed, for a follow-up period of 90 days, verifying a substantial decrease both in total organochlorine compounds (TOCC) and, especially, hexachlorobenzene (HCB), as well as low half-life values, according to Tables 3 and 4 below.

TABLE 3
RESULTS OF TESTS FOR BIODEGRADATION OF TOCC

| | Initial TOCC | Final TOCC | Half-life |
|---|---|---|---|
| Test | mg/kg 0 day | mg/kg 90 days | days |
| Sample I | 6749 | 1111 | 34 |
| Sample II | 6332 | 970 | 34 |

TABLE 4
RESULTS OF TESTS FOR BIODEGRADATION OF HCB

| | Initial HCB | Final HCB | Half-life |
|---|---|---|---|
| Test | mg/kg 0 day | mg/kg 90 days | days |
| Sample I | 5900 | 997 | 35 |
| Sample II | 5380 | 885 | 35 |

Examples 2 and 3 were carried out according to the sequence and the reaction parameters described:

During an anaerobic phase lasting approximately 7 to 10 days, the water retention field capacity of the mixture was maintained between approximately 40% and 70%; the redox potential was below 0 mV and the temperature was between approximately 20° C. and 70° C.

Then, during an aerobic phase, lasting between approximately 5 and 30 days, the redox potential was raised to above 50 mV by means of aeration, maintaining the water retention field capacity between approximately 45% and 65% and the temperature between approximately 20° C. and 70° C.

During the tests, the anaerobic/aerobic sequential cycles were repeated.

### EXAMPLE 2

A treatment cell was charged with 400 kg of soil contaminated with 2% of organochlorine compounds, mainly hexachlorobenzene (HCB), and natural organic substrate constituted of chicken droppings and sawdust, in a proportion of 20% w/w. Then homogenization of the mixture was carried out in the cell, and a temperature measuring probe was installed for monitoring the biological activity of the method.

Next, the cell was closed for the start of the anaerobic stage. This stage was followed by others, alternating the anaerobic/aerobic cycles, with supplementary addition of organic substrate if necessary, based on analytical monitoring of the samples obtained, with the aim of maintaining suitable conditions for degradation.

The tests were performed in duplicate. After some cycles, a substantial decrease both in total organochlorine compounds (TOCC) and, especially, hexachlorobenzene (HCB) was verified, as well as low half-life values, according to Tables 5 and 6 below.

TABLE 5
RESULTS OF TESTS FOR BIODEGRADATION OF TOCC
Evolution of the degradation of TOCC (mg/kg)

| Test | 0 day | 79 d. | 120 d. | 164 d. | 218 d. | 298 d. | 387 d. | 470 d. | Half-life days |
|---|---|---|---|---|---|---|---|---|---|
| 2.1% | 19965 | 18152 | 17183 | 13156 | 11874 | 6443 | 5156 | 2377 | 153 |
| 2.2% | 22395 | 19472 | 18140 | 13569 | 11431 | 5686 | 4766 | 1713 | 127 |

TABLE 6
RESULTS OF TESTS FOR BIODEGRADATION OF HCB
Evolution of the degradation of HCB (mg/kg)

| Test | 0 day | 79 d. | 120 d. | 164 d. | 218 d. | 298 d. | 387 d. | 470 d. | Half-life days |
|---|---|---|---|---|---|---|---|---|---|
| 2.1% | 17717 | 15973 | 15319 | 11522 | 10053 | 5626 | 4369 | 1869 | 145 |
| 2.2% | 19825 | 16891 | 15984 | 11789 | 9732 | 4730 | 3892 | 1299 | 120 |

### EXAMPLE 3

Four treatment cells were charged with a total of 4000 tonnes of soil contaminated with organochlorine compounds, especially hexachlorobenzene (HCB) at initial concentrations of the order of 1000 mg/kg, and about 20% to 40% of natural organic substrate constituted of chicken droppings and sawdust.

This stage was followed by others, alternating the anaerobic/aerobic cycles, based on analytical monitoring of the samples obtained, with the aim of maintaining suitable conditions for degradation.

After some cycles, a substantial decrease was observed, both in total organochlorine compounds (TOCC) and hexachlorobenzene (HCB), as well as low half-life values, according to Tables 7 and 8 below.

TABLE 7
RESULTS OF TESTS FOR BIODEGRADATION OF TOCC
Evolution of the degradation of TOCC (mg/kg)

| Cells | 0 day | 56 days | 155 days | 275 days | Half-life days |
|---|---|---|---|---|---|
| 1 | 683 | 328 | 110 | 44 | 69 |
| 2 | 955 | 548 | 128 | 58 | 68 |
| 3 | 610 | 311 | 236 | 110 | 111 |
| 4 | 116 | 52 | 17 | 8 | 71 |

TABLE 8
RESULTS OF TESTS FOR BIODEGRADATION OF HCB
Evolution of the degradation of HCB (mg/kg)

| Cells | 0 day | 56 days | 155 days | 275 days | Half-life days |
|---|---|---|---|---|---|
| 1 | 627 | 290 | 95 | 34 | 66 |
| 2 | 878 | 465 | 113 | 45 | 64 |
| 3 | 543 | 262 | 209 | 92 | 107 |
| 4 | 99 | 37 | 14 | 6 | 69 |

### EXAMPLE 4

In parallel with example 3, carried out in situ, tests were performed for verifying the effect on the degradation of organochlorine compounds present in the contaminated groundwater under the cells, on an area of approximately 2000 m², due to the percolation of the natural organic substrate in liquid form.

On said area, average samples representative of the groundwater were collected in wells installed at the site, for determining the degradation of the organochlorine compounds, before and after percolation of said substrate in liquid form.

Supply of liquid substrate to the groundwater under the area of soil treated makes it possible to maintain anaerobic conditions, with a redox potential below 0 mV, creating suitable conditions for biostimulation of the indigenous bacteria present in the groundwater, permitting biodegradation of the organochlorine compounds present in the water.

Over a period of 390 days, a substantial decrease in the concentration of total organochlorine compounds (TOCC) present in the groundwater was observed, according to Table 9 below.

TABLE 9
RESULTS OF TESTS FOR BIODEGRADATION OF TOCC
Evolution of the concentration of TOCC in the groundwater (μg/L)

| Days | Concentration TOCC |
|---|---|
| 0 | 2819 |
| 30 | 2281 |
| 60 | 1960 |
| 90 | 1682 |
| 120 | 1747 |
| 150 | 1404 |
| 180 | 1434 |
| 210 | 856 |
| 240 | 349 |
| 270 | 243 |
| 300 | 203 |
| 390 | 30 |

1. A method for the bioremediation of soils contaminated by organic and/or inorganic contaminants, characterized in that it comprises the following stages:
(a) addition of a natural substrate containing nutrients, directly or indirectly to the contaminated soil;
(b) anaerobic rest of the contaminated soil, with a moisture level that is between about 20% and 100% of the field capacity and a temperature between about 15° C. and 70° C.; and
(c) aeration of said soil.

2. The method as claimed in claim 1, characterized in that it comprises one or more cycles of anaerobic and/or aerobic treatment.

3. The method as claimed in either one of claim 1 or 2, characterized in that the natural substrate containing nutrients comprises substances of vegetable and/or animal origin.

4. The method as claimed in claim 3, characterized in that the substrate containing nutrients of vegetable origin is selected from the group comprising wood chips, pieces and/or residues, sawdust, sugarcane bagasse, residues of vegetation and vegetable oil cake.

5. The method as claimed in claim 3, characterized in that the natural substrate containing nutrients of animal origin is selected from the group comprising sludges and/or slurries from animals such as manure from cattle, echinates and poultry, notably chicken droppings, fresh or not.

6. The method as claimed in any one of claims 1 to 5, characterized in that the natural substrate containing nutrients can be added to the contaminated soil in solid and/or liquid form.

7. The method for the bioremediation of contaminated soils as claimed in any one of claims 1 to 6, characterized in that the natural substrate containing nutrients, added to said soil, reaches the water table and/or aquifer contaminated by organic and/or inorganic compounds leading to the bioremediation of said water.

8. The method for the bioremediation of contaminated soils as claimed in any one of claims 1 to 6, characterized in that said method for the bioremediation of contaminated soil comprises a natural substrate containing nutrients added to said soil, and reaches the water table and/or aquifer contaminated by organic and/or inorganic compounds, leading to the bioremediation of said water.

9. A method for the bioremediation of surface water or groundwater contaminated by organic and/or inorganic compounds, characterized in that it comprises the direct or indirect addition of a natural substrate containing nutrients comprising substances of vegetable and/or animal origin to said water.

10. The method as claimed in any one of claims 1 to 8, characterized in that the natural substrate mixture containing nutrients is established according to a rate of approximately 5 to 95 wt. % relative to the contaminated soil.

11. The method as claimed in claim 10, characterized in that the natural substrate mixture containing nutrients is established according to a rate of approximately 30 to 70 wt. % relative to the contaminated soil.

12. The method as claimed in any one of claims 1 to 11, characterized in that it comprises the addition of a source of nitrogen.

13. The method as claimed in claim 12, characterized in that said source of nitrogen comprises mineral nitrogen selected from the group comprising ammonium nitrate, ammonium sulfate, ammonia nitrogen, nitrite and/or mixtures thereof.

14. The method as claimed in any one of claims 1 to 13, characterized in that it comprises the supplementary addition of micronutrients and/or macronutrients and/or additives.

15. The method as claimed in claim 14, characterized in that the additives are selected from the group comprising acids, oxides, peroxides, surfactants, surface-active substances and/or alkaline substances.

16. The method as claimed in any one of claims 1 to 15, characterized in that the pH is between 2 and 12.

17. The method as claimed in claim 16, characterized in that the pH is between 7 and 10.

18. The method as claimed in any one of claims 1 to 17, characterized in that it comprises supplementary addition of microorganisms.

19. The method as claimed in any one of claims 1 to 18, characterized in that the organic compounds present in contaminated soil and/or water comprise halogenated organic compounds.

20. The method as claimed in any one of claims 1 to 19, characterized in that the inorganic compounds present in contaminated soil and/or water comprise oxyhalogenated compounds and/or heavy metals and/or their complexes and/or their salts and/or mixtures thereof.

21. A composition, characterized in that it contains a natural substrate in liquid and/or solid form containing nutrients comprising substances of vegetable and/or animal origin for use in the method for the bioremediation of water and/or soil contaminated by organic and/or inorganic compounds.

22. Use of a natural substrate in liquid and/or solid form containing nutrients comprising substances of vegetable and/or animal origin in a method for the bioremediation of water and/or soil contaminated by organic and/or inorganic compounds.
